(19) United States
(12) Patent Application Publication
(10) Pub. No.: US 2026/0175356 A1
(43) Pub. Date: Jun. 25, 2026

(54) CHEMICAL-MECHANICAL PLANARIZATION PADS AND METHODS

(71) Applicant: ENTEGRIS, INC., Billerica, MA (US)

(72) Inventors: Paul Andre Lefevre, Portland, OR (US); Wei Fan, Naperville, IL (US); Rui Ma, Plainfield, IL (US)

(21) Appl. No.: 19/422,411

(22) Filed: Dec. 16, 2025

Related U.S. Application Data
(60) Provisional application No. 63/738,467, filed on Dec. 23, 2024.

(51) Int. Cl. B24B 37/26; B24B 37/24; C08G 18/48; C09G 1/02

(52) U.S. Cl. CPC B24B 37/26; B24B 37/24; C08G 18/48; C09G 1/02

(57) ABSTRACT

Described are pads and methods used in chemical-mechanical polishing (also referred to as chemical-mechanical planarization) of microelectronic substrates, the pads having a polishing surface that includes rigid sections and compliant sections.

### CROSS-REFERENCE TO RELATED APPLICATION

This application claims priority to and the benefit of United States Provisional Application No. 63/738,467 filed December 23, 2024, the entirety of which is incorporated herein by reference for all purposes.

### FIELD

The present disclosure relates to pads and methods used in chemical-mechanical polishing (also referred to as chemical-mechanical planarization) of microelectronic substrates, wherein the pads have a polishing surface that includes rigid sections and compliant sections.

### BACKGROUND

Microelectronic devices include active electronic structures such as transistors or other operative structures that in turn include connectors, conducting layers, insulating layers, etc., that are formed by deposition methods. During fabrication, layers of material are sequentially deposited onto a substrate surface to produce a large number of microelectronic devices arrayed over a surface area of the substrate. A single substrate (“wafer”) can include hundreds, thousands, or tens-of-thousands of in-process devices (“dies”) arranged as rows and columns over the substrate surface to completely fill the area of the substrate. The individual dies are processed together at the substrate surface by selectively adding or removing materials at the substrate surface, to form the individual components of the dies. To achieve effective, high yield processing, every step of adding or removing material from the dies must be carried out uniformly relative for dies located over the substate surface.

After materials are deposited onto the substrate surface, a planarization process is used to level off (i.e., “planarize”) a deposited material to allow the formation of a subsequent layer. For example, the formation of metallic features or layers may cause uneven topography at the substrate surface. Uneven topography will prevent the formation of subsequent layers on the substrate surface. Therefore, a surface of an in-process microelectronic device substrate is planarized between device formation steps.

Chemical-mechanical Polishing (or “Chemical-mechanical Planarization” or “CMP”) is the practice of selectively removing excess material deposited onto an in-process microelectronic device substrate to level the surface of the substrate. CMP uses the combined effects of physical (mechanical) and chemical forces to remove material from a substrate surface. CMP is performed by applying a load force to the back of the substrate while the substrate contacts a polishing pad. The polishing pad is placed against the substrate and both the polishing pad and the substrate are rotated while a slurry that contains abrasives and reactive chemicals is passed therebetween.

### SUMMARY

The following description relates to CMP pads that have a polishing surface that exhibits variable mechanical properties at different areas (“sections”) of the polishing surface, including harder mechanical properties at a “rigid section” and softer mechanical properties at a “compliant section.” The varied mechanical properties associated with rigid and compliant sections at a polishing surface produce a CMP pad that can be made from relatively hard polymer material (e.g., a CMP pad that has a relatively hard polishing surface) to achieve good planarization efficiency, while also having good WIWNU control, during a CMP process.

In one aspect, the disclosure relates to a polishing pad that includes a polymeric top pad layer and a polymeric sub pad layer. The polymeric top pad comprising includes a polishing surface and a backside that includes a top pad hard section separated by top pad gap sections. The polymeric sub pad includes a sub pad upper surface that contacts the backside, the sub pad upper surface includes a sub pad raised section that contacts the top pad gap section and a sub pad gap that contacts the top pad hard section. The polymeric top pad includes polymer material having a first hardness value. The polymeric sub pad includes polymer material having a second hardness value that is less than the first hardness value.

According to another aspect, the disclosure relates to a polishing pad that includes a pad body having a polishing surface, a backside, a thickness between the polishing surface and the backside, hard sections between the polishing surface and the backside, the hard sections having a width or length dimension of at least 12.5 millimeters, and gap sections that extend along at least a portion of the pad thickness between the hard sections. The pad body includes polymer material having a modulus value greater than 100 MegaPascals, or a Shore D hardness value greater than 50, or both.

According to another aspect, the disclosure relates to a polishing pad that includes: a polymeric top pad having a polishing surface and a backside; a polymeric sub pad having a sub pad upper surface that contacts the backside, support sections, and sub pad gap sections; the polymeric top pad including polymer material having a first hardness value and the polymeric sub pad including polymer material having a second hardness value that is less than the first hardness value.

According to another aspect, the disclosure relates to a method of polishing a microelectronic substrate. The method includes providing a polishing pad having: a polishing surface, a backside having a top pad hard section separated by top pad gap sections, and a polymeric sub pad having a sub pad upper surface that contacts the backside, the sub pad upper surface having a sub pad raised section that contacts the top pad gap section and a sub pad gap that contacts the top pad hard section; the polymeric top pad having polymer material having a first hardness value and the polymeric sub pad having polymer material having a second hardness value that is less than the first hardness value; and contacting a microelectronic substrate surface with the polishing surface with pressure and motion between the microelectronic substrate surface and the top pad polishing surface.

According to another aspect, the disclosure relates to a method of polishing a microelectronic substrate. The method includes: providing a pad body having a polishing surface, a backside, a thickness between the polishing surface and the backside, hard sections between the polishing surface and the backside, the hard sections having a width or length dimension of at least 12.5 millimeters, and gap sections that extend along at least a portion of the pad thickness between the hard sections, wherein the pad body comprises a polymer material having a modulus value greater than 100 MegaPascals, or a Shore D hardness value greater than 50, or both; and contacting a microelectronic substrate surface with the polishing surface with pressure and motion between the microelectronic substrate surface and the top pad polishing surface.

According to another aspect, the disclosure relates to a method of polishing a microelectronic substrate. The method includes: providing a polishing pad having a polymeric top pad having a polishing surface and a backside, a polymeric sub pad having a sub pad upper surface that contacts the backside, the sub pad having sub pad support sections and sub pad gap sections, the polymeric top pad having polymer material having a first hardness value and the polymeric sub pad comprising polymer material having a second hardness value that is less than the first hardness value; and contacting a microelectronic substrate surface with the polishing surface with pressure and motion between the microelectronic substrate surface and the top pad polishing surface.

### BRIEF DESCRITION OF THE DRAWINGS

The disclosure may be more completely understood in consideration of the following description of various illustrative embodiments in connection with the accompanying drawings, in which:

FIG. 1A is a side cross-sectional view of a CMP polishing pad, illustrating a structured top pad layer with recessed sections engaged with a structured sub-pad layer having complementary raised sections in accordance with an embodiment of the disclosure;

FIG. 1B is a top plan view of the CMP polishing pad of FIG. 1A, showing an exemplary annular arrangement of rigid and compliant sections on the polishing surface;

FIG. 2A is a side cross-sectional view of a CMP polishing pad, also illustrating an interlocking structure between a top pad layer and a sub-pad layer in accordance with an embodiment of the disclosure;

FIG. 2B is a top plan view of the CMP polishing pad of FIG. 2A, showing an exemplary grid arrangement of rigid and compliant sections;

FIG. 3A is a side cross-sectional view of a CMP polishing pad, illustrating a top pad layer having through-channels supported by a continuous sub-pad layer in accordance with an embodiment of the disclosure;

FIG. 3B is a side cross-sectional view of a variation of the third embodiment, illustrating a top pad layer with partial-depth channels;

FIGS. 4A-4E are side cross-sectional views of a CMP polishing pad, illustrating a single-layer pad having channels of varying dimensions formed therein in accordance with an embodiment of the disclosure;

FIG. 5 is a side cross-sectional view of a CMP polishing pad, illustrating a continuous top pad layer supported by a sub-pad layer having channels formed therein in accordance with an embodiment of the disclosure;

FIG. 6 is a schematic diagram of a chemical-mechanical planarization (CMP) apparatus suitable for use with the disclosed polishing pads; and

FIG. 7A is a side cross-sectional view and FIG. 7B is a bottom plan view of an exemplary multi-zone polishing head for use in a CMP apparatus.

It is to be understood that the figures are schematic, not necessarily to scale, and are for purposes of illustration and example only.

### DETAILED DESCRITION

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

A known compromise of CMP processing and pad design is the balance between what is referred to as “planarization efficiency” (PE), versus the uniform removal of material at both edge and center locations of a substrate (wafer), referred to as “With-In Wafer Non-Uniformity” (WIWNU) control. Planarization efficiency, or PE, refers to the selective and uniform removal of a surface material type (e.g., metal or a particular metal) from the individual dies on a substrate. WIWNU refers to a uniformity of material removal across an entire surface area of a substrate, particularly at edge surfaces compared to central surfaces of the substrate. CMP pads with stiffer, more rigid mechanical properties—i.e., a “harder” polishing surface—can provide a higher degree of planarization efficiency (better PE); however, such pads tend to offer less control over the removal rate at substrate edges (i.e., lower WIWNU). Thus, there is a need to improve the balance between PE and WIWNU.

The following description relates to CMP pads that include an upper polishing surface that has areas of varied mechanical properties, including areas that are referred to as “rigid sections” that have relatively stiffer and more rigid mechanical properties, and areas referred to as “compliant sections” that are relatively less stiff, less rigid, i.e., more compliant, compared to the rigid sections. The rigid sections of the polishing surface produce a desired PE during a CMP process, and the compliant sections produce desired WIWNU control during a CMP process.

Rigid sections and compliant sections can be formed as part of a polishing surface of a CMP pad by forming a pad that is relatively hard, but that includes structures within the pad, e.g., near the polishing surface or beneath the polishing surface as part of a sub pad, that allow the polishing surface to flex or bend in response to pressure of a wafer against the polishing surface. The structures within the pad that allow the polishing surface to bend include gap sections that interrupt the relatively hard pad in a way that allows movement of the pad at the polishing surface. As used herein, the terms “gap structure” or “gap section” may refer to an open space within the pad body, a region filled with a material softer than the primary polishing material, or a localized reduction in the thickness of the hard top pad material. An effective gap section may be located in the pad near the polishing surface or may be located below the polishing surface, for example in a sub pad. An effective gap section may be an open space in the CMP pad or may be a section of the pad that is relatively soft compared to the hardness of the pad material.

CMP pads that are made of hard polymer materials and that have a relatively hard polishing surface tend to show good planarization but poor removal uniformity (e.g., poor WIWNU control), particularly as reduced control of removal rates at wafer edges. As described herein, a hard polymer material may be used to form a CMP pad, and the addition of gap sections in the CMP pad produces rigid sections and compliant sections at a polishing surface. The rigid sections and compliant sections allow for a degree of movement of portions of the polishing surface in response to contact with a semiconductor substrate. The result is that the CMP pad, formed with a hard polymer material, shows a combination of good planarization performance with useful WIWNU control.

A CMP pad has a polishing surface, a pad bottom, and a thickness between the polishing surface and the pad bottom referred to herein as the “backside”. Example CMP pads may be constructed as a single piece of a single material, referred to as a single pad or sometimes as a “top pad,” that is directly secured to a rotating pad holder (referred to as a “platen”) during a CMP process. Other example CMP pads may be constructed of two or more stacked or layered pieces or layers that include an upper “top pad” and a lower “sub pad,” with the sub pad being secured to the rotating platen during a CMP process.

A polishing surface of a CMP pad as described includes, over its surface, areas of varied mechanical properties, including areas that are referred to as “rigid sections” that have relatively stiffer and more rigid mechanical properties, and areas referred to as “compliant sections” that are relatively less stiff, i.e., less rigid and more compliant, compared to the rigid sections. The rigid sections provide for PE during a CMP process, and the compliant sections provide for WIWNU control during CMP processing.

The mechanical properties (e.g., rigidity, stiffness) of a rigid section and of a compliant section at the polishing surface are a function of the composition and structure the CMP pad at the rigid section and the compliant section, including the structure and composition of the CMP pad below the polishing surface in the thickness direction of the CMP pad between the upper polishing surface and the bottom of the pad.

A rigid section of a polishing surface includes areas of a CMP pad that are made of relatively hard polymer material. A relatively hard polymer material is a polymer material (e.g., a single polymer or a blend of two or more polymers) that has a relatively high measured “hardness value” and is sometimes referred to herein as “hard polymer material.” A “hardness value” of a polymer material can be based on a measured “modulus” value or standard “hardness” test value, e.g., a hardness value as measured by a Shore A or a Shore D hardness test.

As used herein, a hardness value of a polymer material of a CMP pad is a property of a polymer material that is used to form a CMP pad (e.g., a top pad or a sub pad) as opposed to a measured hardness value of a CMP pad (e.g., a top pad or a sub pad) that is formed from the polymer material. The hardness value can be measured as a hardness of a polymer material, in solid (non-porous) form, before the polymer material is used to form a CMP pad (e.g., a top pad or a sub pad).

Examples of useful hard polymer materials include various thermoplastic or thermosetting elastomeric polymer materials that are capable of being formed into a CMP pad as described. Examples include polyurethanes having a desired hardness value.

A specific hardness value of a hard polymer material can be as desired based on a specific design and use of a CMP pad. In terms of modulus, a useful hard polymer material may have a measured modulus value of at least 100 megapascal (MPa), or at least 300 MPa, or at least 500 or 600 MPa as measured using a Dynamic Mechanical Analyzer and ASTM D4065. In terms of a measured Shore D hardness, a useful hard polymer material may have a measured Shore D hardness value of at least 50 or at least 60 measured by ASTM D2240 Standard Test Method for Rubber Property - Durometer Hardness.

As is typical or common, a top pad or a sub pad may be made from a polymer material by processing the polymer material to form a pad that has specific size and shape features, a patterned polishing surface, and a desired morphology within the thickness of the pad, which may be a porous morphology. A porous pad made from a particular polymer material will have a measured hardness value that is different from, e.g., less than, a measured hardness value of the non-porous polymer material used to make the pad.

The polymer material may be a single type of polymer, or a blend of multiple polymer types, e.g., having different chemistries, different molecular weights, or that differ based on other chemical properties or features, with the single polymer or blend, etc., having a measured hardness value as described. Exemplary CMP pads (e.g., a top pad or a sub pad) may be made entirely or substantially entirely of polymer material (a blend or otherwise) that has a measured hardness value as described. For example, a CMP pad (e.g., a top pad or a sub pad) may contain at least 90, 95, or 99 weight percent polymer material having a measured hardness value as described, based on a total weight of the CMP pad.

According to example CMP pads that include a sub pad and a top pad, the top pad can be made of a hard polymer material and the sub pad can be made of polymer material that has a hardness value that is less than the hardness value of the polymer material of the top pad. In terms of modulus, a useful polymer material of a sub pad may have a measured modulus value that is less than the hardness value of the polymer material of the top pad and that is also less than 300 MPa or less than 100 MPa, e.g., in a range from 1 to 100 MPa or from 1 to 50 MPa or from 1 to 10 MPa. In terms of a measured Shore D hardness, a useful polymer material of a sub pad may have a Shore D hardness value that is less than the Shore D hardness value of the polymer material of the top pad, and that is also less than 50, 30, or 20.

A compliant section is an area of a polishing surface that is relatively more compliant or conformable than a rigid section, e.g., that is softer than a rigid section. A compliant section exhibits relatively greater compliance or conformability compared to a rigid section based on a different structure or composition of the compliant section over the area of and along the thickness of the CMP pad at the compliant section. For example, a compliant section of a CMP pad can include structure and materials that are different from a structure or material of a rigid section of the CMP pad, and that produce a desired softer mechanical property (e.g., greater conformability) of the polishing surface at the compliant section.

According to certain examples, a compliant section may include a structure that is referred to as a “gap section.” A gap section may be at any location relative to a thickness of a CMP pad, e.g., as part of a single pad, or as part of top pad or a sub pad that together form a CMP pad. A gap section may be an open, empty space that does not contain a polymeric material. Alternately, a gap section may be a volume of a CMP pad that contains a polymer material that is softer than a hard polymer material, e.g., that has a measured hardness value that is lower than a measured hardness value of a hard polymer material is also used to form the CMP pad. With either example structure, the compliant section of the polishing surface can be an area of the polishing surface that exhibits a higher degree of conformability compared to a level of conformability of a rigid section of the CMP pad.

A CMP pad as described can have any useful thickness that allows for effective use of the CMP pad in a CMP process. A useful thickness of exemplary CMP pads (disregarding a height of structures of a polishing surface) may be in a range from 1 to 10 millimeters. For CMP pads that include both a sub pad and a top pad, a thickness of the top pad (disregarding a height of structures of a polishing surface) may be in a range from 1 to 5 millimeters and a thickness of the sub pad may be in a range from 0.2 to 5 millimeters.

According to some embodiments, a CMP pad can include multiple horizontally-oriented layers that include an upper “top pad” layer and a lower “sub pad” layer, with the top pad and the sub pad each having varied and complementary thicknesses at different sections of each, to produce a polishing surface that includes rigid sections and compliant sections. The top pad has a top pad body having a varied thickness across the area of the top pad, a structured polishing surface on the upper surface of the top pad body, and a top pad backside. The thickness of the top pad body varies according to a pattern of thicker “top pad hard sections” and thinner “top pad gap sections” that each extend over areas of the top pad backside.

The sub pad has a sub pad body that includes a sub pad upper surface that contacts the top pad backside, a sub pad bottom, and a varied thickness between the sub pad upper surface and the sub pad bottom. The thickness of the sub pad body varies between thicker portions referred to as “sub pad raised sections” and thinner portions referred to as “sub pad gap sections.” The top pad body and the sub pad body combine to form the CMP pad with the top pad body being located above the sub pad body, and with the thicknesses of the different sub pad sections and the different top pad hard sections being complementary, combining to make up a relatively uniform total thickness across the area of the CMP.

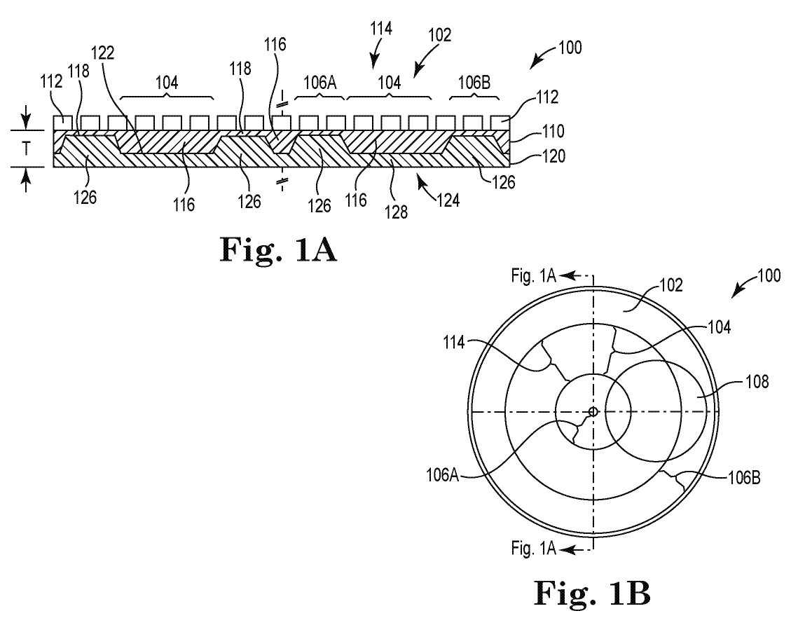

Referring to FIGS. 1A and 1B, a CMP pad 100 includes top pad body 110 and sub pad body 120, which combine to form CMP pad 100 having a total CMP pad thickness “t” (disregarding the height of polishing structures 112, which may vary based on a particular CMP process, slurry, and substrate being processed). Polishing surface 102 (having polishing structures 112 supported thereon) is at upper surface 114 of CMP pad 100 and includes rigid region 104 and compliant regions 106A and 106B, as described herein. Top pad body 110 has a varied thickness over different areas of body 110, including a greater thickness at top pad hard sections 116, and a reduced thickness at top pad gap sections 118. Sub pad body 120 includes sub pad upper surface 122, sub pad bottom 124, and has a varied thickness over the area of sub pad body 120, including a greater thickness at sub pad raised sections 126 and reduced thickness at sub pad gap sections 128.

As shown, the total thickness (t) of example CMP pad 100 is relatively uniform over the area of CMP pad 100, being equal to the combined thicknesses of top pad hard sections 116 and sub pad gap sections 128 at rigid section 104, and being equal to the combined thicknesses of top pad gap sections 118 and sub pad raised sections 126 at compliant sections 106A and 106B. To produce rigid section 104 and compliant sections 106, top pad body 110 is made of hard polymer material having a relatively high hardness value as described herein, and sub pad body 120 is made of polymer material that has a hardness value that is less than the hardness value of the hard polymer material of top pad body 110.

In this example, rigid sections 104 and compliant sections 106A and 106B are arranged in a radial (circular, annular) pattern with compliant section 106A being located at a radially-inner region of polishing surface 102, rigid section 104 being located at a more distant (medial radius location) based on a radial distance from a center of CMP pad 100, and another compliant section 106B being more radially distant from the center of CMP pad 100. Compliant sections 106A and 106B have an increased conformability, i.e., reduced rigidity or hardness, relative to rigid section 104 due to the reduced thickness of top pad body 110 at top pad gap section 118 and the greater thickness of sub pad body 120 at sub pad raised sections 126. Conversely, rigid section 104 of polishing surface 102 has an increased rigidity, i.e., greater hardness, relative to

compliant sections 106A and 106B due to the greater thickness of top pad body 110 at top pad hard section 116 and the reduced thickness of sub pad body 120 at sub pad gap section 128.

Advantageously, as shown by the top view at FIG. 1B, the arrangement of polishing surface 102 having rigid section 104 at a middle-radius portion and compliant sections 106A and 106B at an inner-radius portion and at an outer-radius portion provides a useful balance of PE and WIWNU when CMP pad 100 is used in a CMP process. Rigid section 104 at the middle-radius portion of polishing surface 102 contacts the center and also the edge of wafer 108 during CMP processing, to produce a high planarization efficiency. The compliant sections 106A and 106B at the inner-radius and the outer-radius portion contact only edge surfaces of wafer 108, to provide desirable WIWNU control.

According to other examples, a CMP pad can include a top pad and a sub pad that have varied and complementary thicknesses at different sections to produce a polishing surface that includes rigid sections and compliant sections as described, with the rigid sections arranged as a regular or repeating pattern of geometric shapes (e.g., squares) over the area of the polishing surface. The top pad has a top pad body having a varied thickness, a structured polishing surface on the upper surface of the top pad body, and a top pad backside. The thickness of the top pad body varies according to a pattern of thicker top pad hard sections and thinner top pad gap sections that each extend over areas of the backside of the top pad body.

The sub pad has a sub pad body that includes a sub pad upper surface that contacts the backside of the top pad body, a sub pad bottom, and a varied thickness between the sub pad upper surface and the sub pad bottom. The thickness of the sub pad body varies between thicker portions referred to as “sub pad raised sections” and thinner portions referred to as “sub pad gap sections.” The top pad body and the sub pad body combine to form the CMP pad with the top pad body being located above the sub pad body, and with the thicknesses of the different sub pad sections and the different of the top pad sections combining to make up a total thickness of the CMP pad that is relatively uniform over the area of the CMP pad.

According to such exemplary CMP pads, multiple individual, geometrically-shaped top pad hard sections are separated by gaps (“gap sections”) between the individual top pad hard sections. The gap sections contain polymer of the sub pad raised sections to produce a polishing surface that includes a repeating pattern of many individual rigid sections that include the top pad hard sections separated by compliant sections that include the gaps filled with polymer of the sub pad raised sections. The top pad hard sections are made of hard polymer material and are separated by gaps that contain polymer material of the sub pad raised sections that has a lower hardness value compared to the hard polymer material of the top pad. This arrangement produces an effect of the individual top pad hard sections, which are separated by the sub pad raised sections, having a level of mobility relative to the polishing surface, with the individual top pad hard sections being able to move and conform (e.g., “float”) relative to the polishing surface as a substrate contacts and applies pressure to the polishing surface.

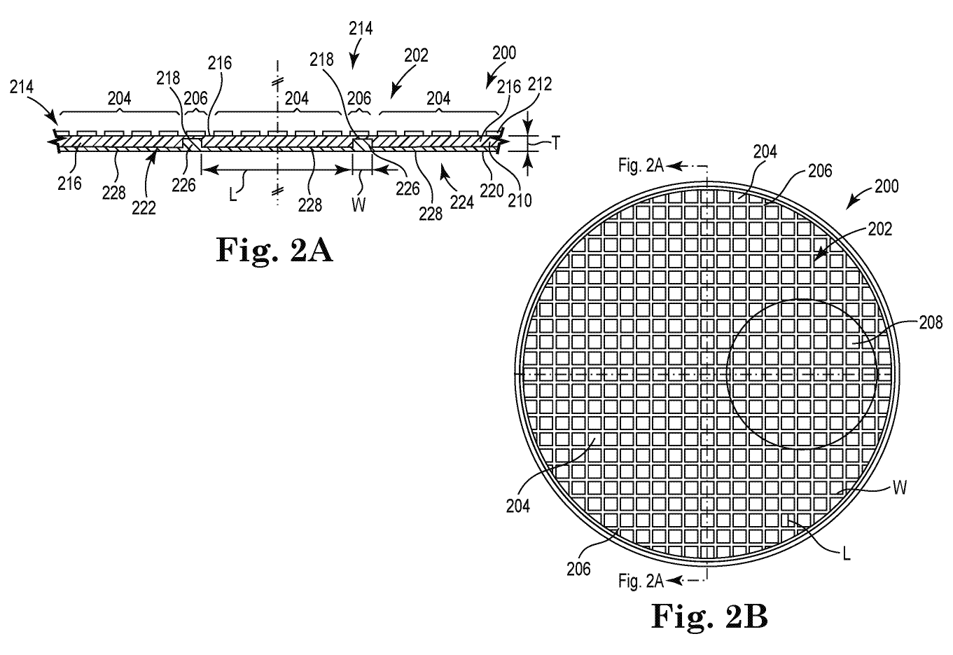

According to certain examples, at least one dimension of the top pad hard sections is of a scale that is similar to a dimension of an individual die at a surface of a wafer for which the CMP pad is used in a CMP process. An exemplary top pad hard section may be a square with sides that have a length that is slightly greater than a dimension of the individual dies at the wafer surface. Specific examples of useful dimensions of a top pad hard section may be square with sides having length dimensions (“L” at FIG. 2A) of at least 6 millimeters by at least 6 millimeters (e.g., at least 12 mm by 12 mm), or square with sides having length dimensions of up 50 millimeters by up to 50 millimeters. Specific examples of a sub pad raised section may be linear, extending between the top pad hard sections, and with a width (“W”) of at least 0.5 millimeters, up 15 millimeters. In terms of the relative areas, viewed from a top of the CMP pad, a ratio of the total area of top pad hard sections to the total area of sub pad raised sections may be at least 3:1, e.g., at least 5:1.

This combination of top pad hard sections made of hard polymer material and having such example dimensions, and sub pad raised sections made of polymer material having a lower hardness value and having such example dimensions, results in a CMP pad with a polishing surface that includes rigid sections that include the top pad hard sections, and compliant sections that include the sub pad raised sections such that the CMP pad can be used to achieve a desirable combination of PE and With-In Die Non-Uniformity (WIWDU) control, e.g., good wafer edge removal rate control.

FIGS. 2A and 2B shown an exemplary CMP pad 200 according to an embodiment of the disclosure. Referring to FIGS. 2A and 2B, CMP pad 200 includes top pad body 210 and sub pad body 220, which combine to form CMP pad 200 having a relatively uniform total CMP pad thickness “t” across the area of the CMP pad (disregarding the height of the features of structured polishing surface 202). Polishing surface 202 (having polishing structures 212 (not to scale) supported thereon) is at upper surface 214 of CMP pad 200 and includes rigid sections 204 and compliant sections 206, as described herein. Top pad body 210 has a varied thickness over different areas of body 210, including a greater thickness at top pad hard sections 216, and a reduced thickness at top pad gap sections 218. Sub pad body 220 includes sub pad upper surface 222, sub pad bottom 224, and has a varied thickness over areas of sub pad body 220, including a greater thickness at sub pad raised sections 226 and reduced thickness at sub pad gap sections 228. In use during CMP processing, the bottom surface of sub pad body 200 can be directly secured to a rotating platen of a CMP processing tool.

As shown, the total thickness (t) of example CMP pad 200 is relatively uniform over the area of CMP pad 200, being equal to the combined thicknesses of top pad hard sections 216 and sub pad gap sections 228 at rigid sections 204, and being equal to the combined thicknesses of top pad gap sections 218 and sub pad raised sections 226 at compliant sections 206. Length L of top pad hard sections 216 can be as described, e.g., a length greater than a die at a surface of a wafer for which CMP pad 200 is used to process. Example lengths L can be at least 6 millimeters or, in some cases, at least 15 millimeters. Width W of top pad gap sections 218 can range from 0.5 to 15 millimeters. To produce rigid sections 204 and compliant sections 206, top pad body 210 is made of hard polymer material having a relatively high hardness value as described herein, and sub pad body 220 is made of polymer material that has a hardness value that is less than the hardness value of the hard polymer material of top pad body 210.

Polishing surface 202 includes rigid sections 204 and compliant sections 206 arranged in a pattern of geometric shapes with geometrically-shaped rigid sections 204 being separated by linear compliant sections 206. Compliant sections 206 have increased conformability, i.e., reduced rigidity or hardness, relative to rigid sections 204, due to the reduced thickness of top pad body 210 at top pad gap section 218 and a greater thickness of sub pad body 220 at sub pad raised sections 226. Conversely, rigid sections 204 have increased rigidity, i.e., greater hardness, relative to compliant sections 206 due to the greater thickness of top pad body 210 at top pad hard section 216 and a reduced thickness of sub pad body 220 at sub pad gap section 228.

Advantageously, and particularly with dimensions of top pad hard sections being of a size that is comparable to or slightly greater than a size of a die on a wafer being processed by CMP pad 200, rigid portions 204 of polishing surface 202 produce a high planarization efficiency, while compliant sections 206 to provide desirable WIWNU control.

According to other embodiments, a CMP pad can include a top pad and a sub pad with the top pad having top pad hard sections separated by top pad gap sections that are empty of polymer. The top pad gap sections (open spaces) separate and extend between the top pad hard sections to produce a polishing surface that includes rigid sections that include the top pad hard sections and compliant sections that include the top pad gap sections. The rigid sections include the top pad hard sections and are arranged as geometric shapes (e.g., squares) on the polishing surface, separated by the top pad gap sections, which are part of the compliant sections. The top pad gap sections are open spaces, i.e., do not contain a polymer material of the top pad or of the sub pad (if present), and may extend along the entire thickness (depth) of the top pad or along a portion of the thickness of the top pad. Dimensions (“L” and “W”) of the top pad hard sections and the top pad gap sections and the dimensions of the rigid sections and the compliant sections of these example CMP pads can be similar to dimensions of top pad hard sections and top pad gap sections of FIGS. 2A and 2B.

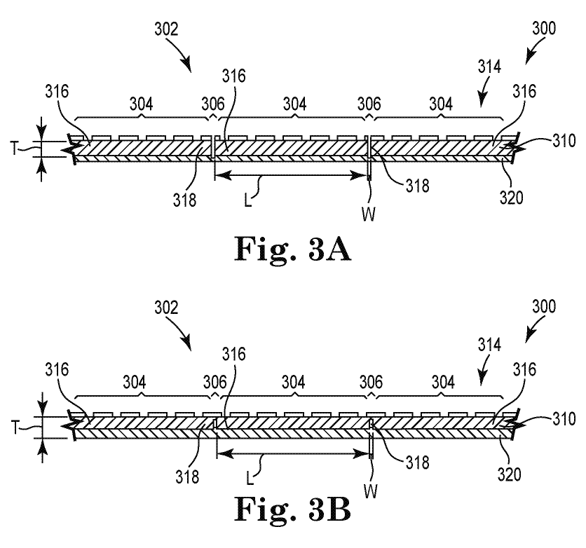

FIGS. 3A and 3B show a CMP pad 300 according to another embodiment of the disclosure. As shown in FIGS. 3A and 3B, CMP pad 300 includes top pad body 310 and sub pad body 320, which combine to form CMP pad 300 having a relatively uniform total CMP pad thickness “t.” Polishing surface 302 at upper surface 314 of CMP pad 300 includes rigid sections 304 and compliant sections 306 as described herein. Geometrically-shaped top pad hard sections 316 are separated by linear top pad gap sections 318. Length L of top pad hard sections 316 can be as described, and as illustrated can be in a range from 20 to 30 millimeters. Width W of top pad gap sections 318 can be as described, and as illustrated can be in a range from 0.5 to 2 millimeters. Top pad body 310 and rigid sections 304 can be made of a hard polymer material having a relatively high hardness value as described herein, and sub pad body 320 can be made of polymer that has a hardness value that is less than the hardness value of the hard polymer material of top pad body 310. In terms of a measured Shore D hardness, a useful hard polymer material for top pad body 31 may have a measured Shore D hardness value of at least 50 Shore D or at least 60 Shore D. A useful polymer material of a sub pad may have a Shore D hardness value that is less than the Shore D hardness value of the polymer material of the top pad, and that is also less than 50, 30, or 20 Shore D. Shore D hardness is measured by ASTM D2240 Standard Test Method for Rubber Property - Durometer Hardness.

As shown at FIG. 3A, top pad gap sections 318 may extend the entire thickness of top pad body 310 from an upper surface of top pad body 310 to a lower surface of top pad body 310. Alternatively, as shown at FIG. 3B, top pad gap sections 318 may extend along only a portion of the total thickness of top pad body 310.

Compliant sections 306 have increased conformability, i.e., reduced rigidity or hardness, relative to rigid sections 304, due to the presence of top pad gap sections 318 between top pad hard sections 316, and the absence of polymer within top pad gap sections 318. Advantageously, with the dimensions of top pad hard sections 316 being of a size that is comparable to or slightly greater than a size of a die on a wafer being processed by CMP pad 300, rigid portions 304 produce a high planarization efficiency while compliant sections 306 provide desirable WIWNU control.

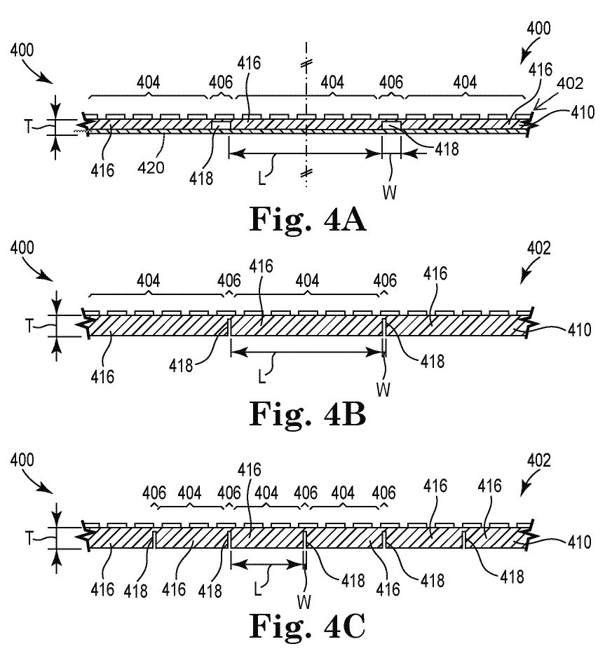

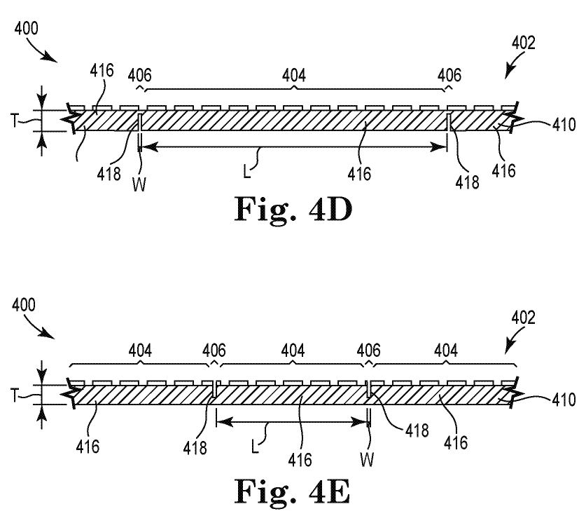

In some embodiments, a CMP pad includes only a single pad component (referred to as a “top pad”). FIGS. 4A, 4B, 4C, 4D, and FIG. 4E show an exemplary CMP pad 400 including top pad body 410 having a thickness “T.” CMP pad 400 does not include a sub pad body supporting top bad body 410. A bottom surface of top pad body 410 can be attached directly at platen (420 at FIG. 4A) with no intervening sub pad.

As shown in FIGS. 4A-4E, top pad 400 includes top pad hard sections 416 separated by top pad gap sections 418 that extend between the top pad hard sections 416. Top pad hard sections 416 and top pad gap sections 418 define polishing surface 402. Polishing surface 402 includes a plurality of rigid sections 404 and a plurality of compliant sections 406. Rigid sections 404 correspond to and include top pad hard sections 416 and compliant sections 406 correspond to and include top pad gap sections 418. Compliant sections 406 have an increased conformability, i.e., reduced rigidity or hardness, relative to rigid sections 404 due to the reduced thickness or absence of material at top pad gap sections 418 relative to a thickness of top pad hard sections. Conversely, rigid sections 404 of polishing surface 402 have an increased rigidity, i.e., greater hardness, relative to compliant sections 406 due to the greater thickness of top pad body 410 at top pad hard sections 416 relative to a thickness of top pad gap sections 418.

In the embodiments illustrated by FIGS. 4A-4E, top pad gap sections 418 can be defined by a gap or an open space extending partially through top pad body 410 in a thickness direction. As used herein, the term “gap” or “open space” refers to absence of material. The open space or gap of top pad gap section 418 can define a thinned-out portion of top pad body 410 having a thickness that is less than a total thickness T of top pad gap body 410.

Top pad body 410 including top pad hard sections 416 can be made of hard polymer material having a relatively high hardness value. In terms of a measured Shore D hardness, a useful hard polymer material for top pad body 410 may have a measured Shore D hardness value of at least 50 Shore D or at least 60 Shore D as measured by ASTM D2240 Standard Test Method for Rubber Property - Durometer Hardness.

In some embodiments, top pad hard sections 416 can have a geometric shape defined by the top pad gap sections 418 disposed between and separating top pad hard sections 416. Suitable geometric shapes of top pad hard sections 416 can include any polygonal shape including but not limited to square, rectangular, hexagonal, diamond, but are not limited to these. In one embodiment, top pad hard sections 416 are square-shaped such that together with top pad gap sections 418 they define a grid pattern in top pad body 410. In another embodiment, top pad hard sections are hexagonal such that together with top pad gap sections 418 they form a honeycomb pattern in top pad body 410. The geometric shape of the top pad hard sections 416 defines the geometrical shape of the corresponding shaped rigid sections 404 in polishing surface 402.

The dimensions of top pad hard sections 416 can be comparable to or slightly greater than a size of a die on a wafer to be processed by CMP pad 400. The dimensions (“L” and “W”) of top pad hard sections 416 and the top pad gap sections 418 and the dimensions of the corresponding rigid sections and the compliant sections of these example CMP pads can be similar to dimensions of top pad hard sections and top pad gap sections of FIGS. 2A and 2B. For example, as shown at FIG. 4A and 4B, length L can be at least 6 millimeters or at least 12 millimeters and width W can range from 0.5 to 15 millimeters. As shown at FIG. 4C, length L can range from 10 to 15 millimeters and width W can range from 0.5 to 2 millimeters. As shown at FIG. 4D, length L can range from 40 to 60 millimeters and width W can range from 0.5 to 2 millimeters. As shown at FIG. 4E, length L can be at least 6 millimeters or at least 12 millimeters and width W can be in a range from 0.5 to 15 millimeters.

In each example of CMP pad 400 illustrated by FIGS. 4A, 4B, 4C, 4D, and FIG. 4E, compliant sections 406 have increased conformability, i.e., reduced rigidity or hardness, relative to rigid sections 404, due to the presence of top pad gap sections 418 between top pad hard

sections 416, and the gap or open space defining top pad gap sections 418. Advantageously, with the dimensions of top pad hard sections 416 being of a size that is comparable to or slightly greater than a size of a die on a wafer being processed by an example CMP pad 400, rigid portions 404 of CMP pad 400 produce a high planarization efficiency while compliant sections 406 of CMP pad 400 provide desirable WIWNU control.

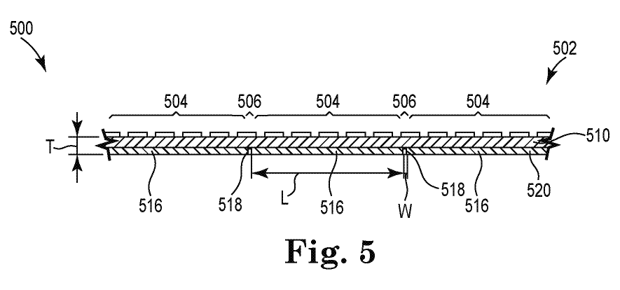

According to another embodiment, as shown in FIGS. 5 (side cut-away view), a CMP pad can include a top pad that is continuous with a uniform thickness over the area of the CMP Pad, and a sub pad that includes sub pad support sections separated by sub pad gap sections. The sub pad gap sections (e.g., open spaces) separate and extend between the sub pad support sections to create areas of varied support of the continuous top pad to produce a polishing surface that includes rigid sections where the top pad is supported by sub pad support sections, and compliant sections that are aligned with and located above the sub pad gap sections. The sub pad support sections can be arranged as geometric shapes (e.g., squares, see FIG. 2B) below the top pad, and are separated by the sub pad gaps. The areas of the polishing surface above the sub pad gap sections are part of the compliant sections. The sub pad gap sections can be open spaces, i.e., do not contain a polymer material of the top pad or of the sub pad, and may extend along the entire thickness (depth) of the top pad or along a portion of the thickness of the top pad. Dimensions (“L” and “W”) of the sup pad support sections and the sub pad gap sections and the dimensions of the rigid sections and the compliant sections of these example CMP pads can be similar to dimensions of top pad hard sections and top pad gap sections of FIGS. 2A and 2B.

As shown at FIG. 5, exemplary CMP pad 500 includes top pad body 510 and sub pad body 520, which combine to form CMP pad 500 having thickness “t.” Polishing surface 502 of CMP pad 500 includes rigid sections 504 and compliant sections 506 as described herein. Geometrically-shaped sub pad support sections 516 are separated by top sub pad gaps 518. Length L of sub pad support sections 516 can be as described elsewhere herein as dimensions of top pad hard sections (e.g., as at FIGS. 2A, 2B, 3A, 3B, 4A, 4B, 4C, 4D, and FIG. 4E), and may, for example, range from 10 to 60 millimeters, 10 to 50 millimeters, 10 to 40 millimeters, 10 to 30 millimeters or from 20 to 30 millimeters. Width W of sub pad gap sections 518 can be as described and can range from 0.5 to 15 millimeters, 0.5 to 10 millimeters, 0.5 to 5 millimeters, 1 to 15 millimeters, 1 to 10 millimeters, 1 to 5 millimeters, 2 to 15 millimeters, 2 to 10 millimeters, or 2 to 5 millimeters.

Top pad body 510 can be made of hard polymer material having a relatively high hardness value as described herein, and sub pad body 520 can be made of polymer material that has a hardness value that is less than the hardness value of the hard polymer material of top pad body 510. As shown at FIG. 5, sub pad gap sections 518 may extend the entire thickness of sub pad body 510. Alternately, sub pad gap sections 518 may extend along only a portion of the total thickness of top pad body 510.

Compliant sections 506 have increased conformability, i.e., reduced rigidity or hardness, relative to rigid sections 504 due to the presence of sub pad gap sections 518 between sub pad support sections 516. As a result, rigid sections 504 advantageously produce a high planarization efficiency while compliant sections 506 provide desirable WIWNU control.

The CMP pads that are described herein according to the various embodiments can be used in a chemical-mechanical planarization process for processing a microelectronic device substrate that contains an array of many hundreds or thousands of dies on the substrate surface. A typical CMP process includes a platen to which the CMP pad is attached, and a polishing head which holds the wafer and presses the surface of the wafer against the pad. The head and the platen both rotate in the same direction, while chemical slurry is delivered continuously on the pad.

Due to stress concentration, the pad-wafer contact stress near the wafer edge generally is much higher than that near the wafer center, resulting in non-uniformity material removal rate across the wafer radial position. One method to alleviate this problem is to divide the polishing head into a number of concentric zones, with different pressures being applied to different zones individually. In doing this, it is possible to adjust the contact stress distribution on the pad-wafer interface and improve the within wafer non-uniformity across the radial position.

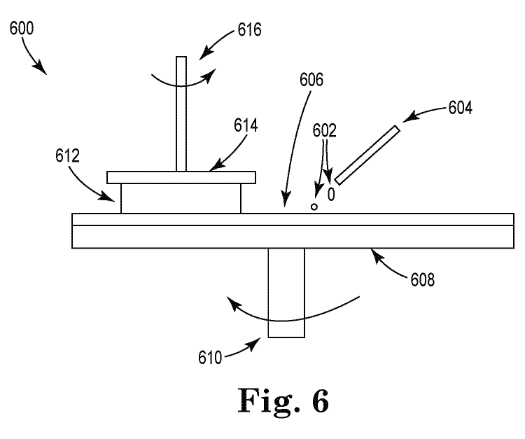

FIG. 6 schematically shows features of a CMP apparatus 600. Slurry 602 is typically dispensed via a slurry dispenser 604 onto the CMP pad 606. Alternatively, slurry 602 may be delivered from the bottom of pad 606 or to the surface of pad 606. The CMP pad 606 is mounted on rotatable platen 608, from which a rotatable platen shaft 610 extends. The substrate (wafer) 612 is held by a substrate chuck (or “head”) 614, from which a substrate chuck shaft 616 extends. The arrows show the direction of vector forces which act to rotate the CMP pad 606 and substrate head 614, and hence substrate 612. A down force is controllably applied to substrate head 614 via the shaft 616, providing controllable contact between the CMP pad 606 and substrate 612.

Due to stress concentration, the pad-wafer contact stress near the wafer edge generally is much higher than that near the wafer center, resulting in a non-uniform material removal rate across the wafer at different radial positions, particularly at edge locations. One technique to alleviate this problem is to divide the polishing head into a number of concentric zones (e.g., 3, 4, or 5 concentric zones) to apply different amounts of pressure to different radial zones (annular areas) of the substrate. The use of a head that applies different pressures to multiple annular zones of the substrate allows the process to adjust pressure distribution (contact stress distribution) over different areas of the interface between the pad and the substrate surface, to improve the within wafer non-uniformity (WIWNU) across the radial position.

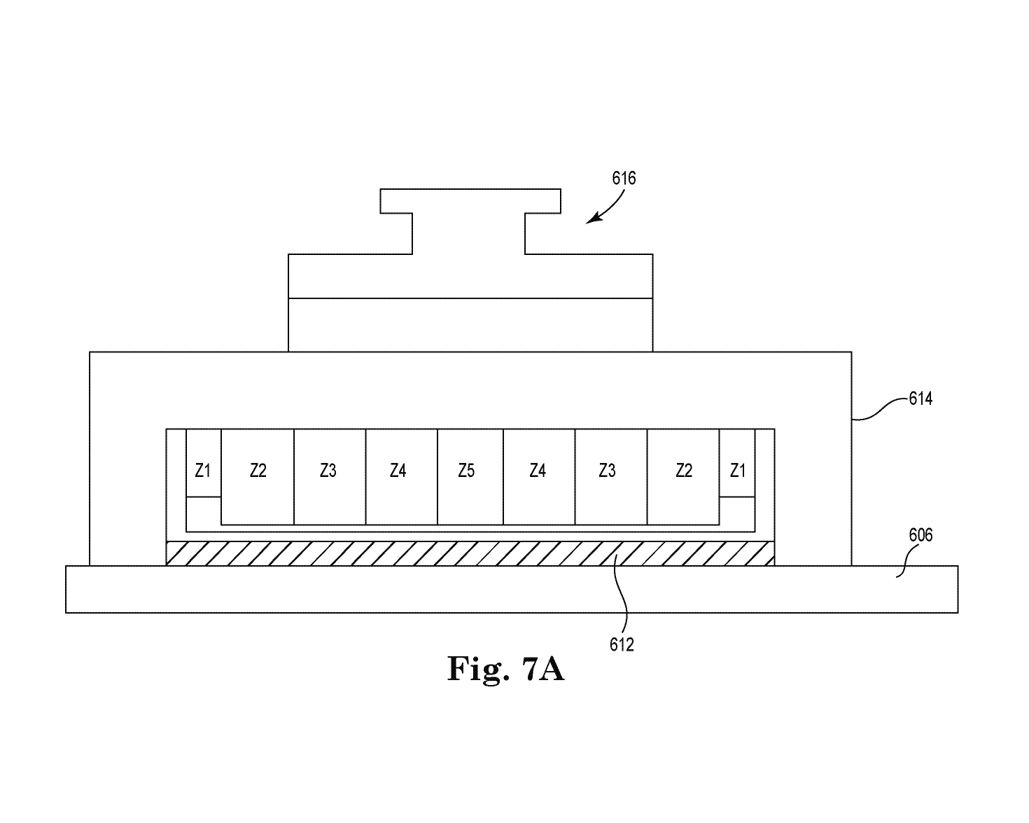

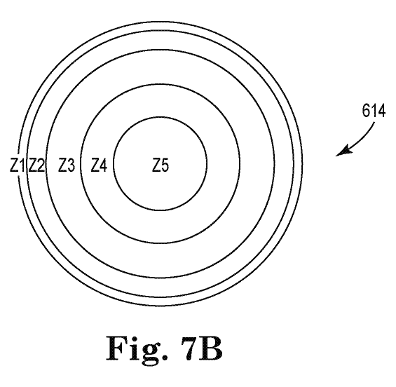

According to example CMP processes using a CMP pad as described, a CMP apparatus (e.g., 600) includes a multi-zone head 614 which applies different amounts of pressure to the substrate at the different concentric zones. Referring to FIGS. 7A (cross section cut-away view) and 7B (bottom view), a head 614 is illustrated as having five concentric pressure zones: Z1 (at an edge), Z5 (at a center) and Z2, Z3, and Z4 at intermediate locations between Z1 and Z5. The pressure applied to substrate 612 can be controlled independently in each zone to apply a different amount of pressure to substrate 612 at the concentric regions of the zones.

### Aspects

Aspect 1 is a polishing pad adapted to polish a microelectronic substrate, the polishing pad comprising: a polymeric top pad comprising a polishing surface and a backside comprising a top pad hard section separated by top pad gap sections; and a polymeric sub pad comprising a sub pad upper surface that contacts the backside, the sub pad upper surface comprising a sub pad raised section that contacts the top pad gap section and a sub pad gap that contacts the top pad hard section; the polymeric top pad comprising polymer material having a first hardness value and the polymeric sub pad comprising polymer material having a second hardness value that is less than the first hardness value.

Aspect 2 includes the polishing pad of Aspect 1, wherein the first hardness value is a modulus value greater than 100 MegaPascals.

Aspect 3 includes the polishing pad of any one of Aspects 1 through 2, wherein the first modulus value is a modulus value greater than 300 MegaPascals.

Aspect 4 includes the polishing pad of any one of Aspects 1 through 3, wherein the second hardness value is a modulus value below 10 Megapascals.

Aspect 5 includes the polishing pad of any one of Aspects 1 through 4, wherein the first hardness value is a Shore D hardness value greater than 50.

Aspect 6 includes the polishing pad of Aspect 5, wherein the first hardness value is a Shore D hardness value greater than 60.

Aspect 7 includes the polishing pad of any one of Aspects 1, or 5 through 6, wherein the second hardness value is a Shore D hardness value below 30.

Aspect 8 includes the polishing pad of any one of Aspects 1 through 7, wherein the top pad comprises an annular top pad hard section and an annular top pad gap section.

Aspect 9 includes the polishing pad of any one of Aspects 1 through 8, wherein the top pad comprises repeating geometrically-shaped top pad hard sections separated by channel-shaped top pad gap sections.

Aspect 10 includes the polishing pad of Aspect 9, wherein a ratio of an area of top pad hard sections to an area of top pad gap sections is greater than 3 to 1.

Aspect 11 includes the polishing pad of any one of Aspects 9 through 10, wherein the top pad hard sections are square-shaped and have a length dimension in a range from 6 millimeters to 60 millimeters.

Aspect 12 includes the polishing pad of any one of Aspects 9 through 11, wherein the channel-shaped top pad gap sections have a width in a range from 0.5 to 15 millimeters.

Aspect 13 is a polishing pad adapted to polish a microelectronic substrate, the polishing pad comprising: a pad body comprising a polishing surface, a backside, a thickness between the polishing surface and the backside, hard sections between the polishing surface and the backside, the hard sections having a width or length dimension of at least 12.5 millimeters, and gap sections that extend along at least a portion of the pad thickness between the hard sections, wherein the pad body comprises polymer material having a modulus value greater than 100 MegaPascals, or a Shore D hardness value greater than 50, or both.

Aspect 14 includes the polishing pad of Aspect 13, wherein the pad body comprises polymer material having a modulus value of at least 100 MegaPascals.

Aspect 15 includes the polishing pad of any one of Aspects 13 through 14, wherein a ratio of an area of the hard sections to the area of the gap sections is at least 3 to 1.

Aspect 16 includes the polishing pad of any one of Aspects 13 through 15, wherein the hard sections are square-shaped and have a length and width dimension in a range from 12.5 to 60 millimeters.

Aspect 17 includes the polishing pad of any one of Aspects 13 through 16, wherein the gap sections have a width in a range from 0.5 to 12 millimeters.

Aspect 18 includes the polishing pad of any one of Aspects 13 through 17, wherein the gap sections are open at the polishing surface.

Aspect 19 includes the polishing pad of any one of Aspects 13 through 18, wherein the gap sections are open at the backside.

Aspect 20 includes the polishing pad of any one of Aspects 13 through 19, comprising a polymeric sub pad that contacts the backside, wherein the gap sections are unfilled.

Aspect 21 includes the polishing pad of any one of Aspects 13 through 19, comprising a polymeric sub pad that contacts the backside, wherein the gap sections are filled with polymer material of the polymeric sub pad.

Aspect 22 includes the polishing pad of Aspect 21, wherein the sub pad comprises polymer material having: a modulus below 10 MegaPascals, or a Shore D hardness value below 30, or both.

Aspect 23 is a polishing pad adapted to polish a microelectronic substrate, the polishing pad comprising: a polymeric top pad comprising a polishing surface and a backside; and a polymeric sub pad comprising a sub pad upper surface that contacts the backside, the sub pad comprising sub pad support sections and sub pad gap sections; the polymeric top pad comprising polymer material having a first hardness value and the polymeric sub pad comprising polymer material having a second hardness value that is less than the first hardness value.

Aspect 24 includes the polishing pad of Aspect 23, wherein the polymeric top pad comprises polymer material having: a modulus value greater than 100 MegaPascals, or a Shore D hardness value greater than 50, or both.

Aspect 25 includes the polishing pad of any one of Aspects 23 through 24, wherein the polymeric sub pad comprises polymer material having: a modulus value below 10 MegaPascals, or a Shore D hardness value below 30, or both.

Aspect 26 is a method of polishing a microelectronic substrate, the method comprising: providing a polishing pad comprising a polishing surface, a backside comprising a top pad hard section separated by top pad gap sections, and a polymeric sub pad comprising a sub pad upper surface that contacts the backside, the sub pad upper surface comprising a sub pad raised section that contacts the top pad gap section and a sub pad gap that contacts the top pad hard section, the polymeric top pad comprising polymer material having a first hardness value and the polymeric sub pad comprising polymer material having a second hardness value that is less than the first hardness value; and contacting a microelectronic substrate surface with the polishing surface with pressure and motion between the microelectronic substrate surface and the top pad polishing surface.

Aspect 27 includes the method of Aspect 26, wherein the first hardness value is a modulus value greater than 100 MegaPascals.

Aspect 28 includes the method of any one of Aspects 26 through 27, wherein the second hardness value is a modulus value below 10 megapascals.

Aspect 29 includes the method of any one of Aspects 26 through 28, wherein the first hardness value is a Shore D hardness value greater than 50.

Aspect 30 includes the method of Aspect 29, wherein the second hardness value is a Shore D hardness value below 30.

Aspect 31 includes the method of any one of Aspects 26 through 30, wherein the top pad comprises an annular top pad hard section and an annular top pad gap section.

Aspect 32 includes the method of any one of Aspects 26 through 31, wherein the top pad comprises geometrically-shaped top pad hard sections separated by channel-shaped top pad gap sections.

Aspect 33 includes the method of any one of Aspects 26 through 32, wherein a ratio of an area of top pad hard sections to an area of top pad gap sections is greater than 3 to 1.

Aspect 34 includes the method of any one of Aspects 26 through 33, further comprising holding the microelectronic device substrate using a head that applies varied pressure at multiple zones across the area of the microelectronic device substrate.

Aspect 35 is a method of polishing a microelectronic substrate, the method comprising: providing a pad body comprising a polishing surface, a backside, a thickness between the polishing surface and the backside, hard sections between the polishing surface and the backside, the hard sections having a width or length dimension of at least 12.5 millimeters, and gap sections that extend along at least a portion of the pad thickness between the hard sections, wherein the pad body comprises polymer material having a modulus value greater than 100 MegaPascals, or a Shore D hardness value greater than 50, or both; and contacting a microelectronic substrate surface with the polishing surface with pressure and motion between the microelectronic substrate surface and the top pad polishing surface.

Aspect 36 includes the method of Aspect 35, wherein the pad body comprises polymer material having a modulus value of at least 100 MegaPascals.

Aspect 37 includes the method of any one of Aspects 35 through 36, wherein a ratio of an area of the hard sections to the area of the gap sections is at least 3 to 1.

Aspect 38 includes the method of any one of Aspects 35 through 37, wherein the hard sections are square-shaped and have a length and width dimension in a range from 12.5 to 60 millimeters.

Aspect 39 includes the method of any one of Aspects 35 through 38, wherein the gap sections have a width in a range from 0.5 to 12 millimeters.

Aspect 40 includes the method of any one of Aspects 35 through 39, further comprising holding the microelectronic device substrate using a head that applies varied pressure at multiple zones across the area of the microelectronic device substrate.

Aspect 41 is a method of polishing a microelectronic substrate, the method comprising: providing a polishing pad comprising a polymeric top pad comprising a polishing surface and a backside, and a polymeric sub pad comprising a sub pad upper surface that contacts the backside, the sub pad comprising sub pad support sections and sub pad gap sections, the polymeric top pad comprising polymer material having a first hardness value and the polymeric sub pad comprising polymer material having a second hardness value that is less than the first hardness value; and contacting a microelectronic substrate surface with the polishing surface with pressure and motion between the microelectronic substrate surface and the top pad polishing surface.

Aspect 42 includes the method of Aspect 41, wherein the polymeric top pad comprises polymer material having: a modulus value greater than 100 MegaPascals, or a Shore D hardness value greater than 50, or both.

Aspect 43 includes the method of any one of Aspects 41 through 42, wherein the polymeric sub pad comprises polymer material having: a modulus value below 10 MegaPascals, or a Shore D hardness value greater than 30, or both.

Aspect 44 includes the method of any one of Aspects 41 through 43, further comprising holding the microelectronic device substrate using a head that applies varied pressure at multiple zones across the area of the microelectronic device substrate.

The foregoing description illustrates several embodiments of the present disclosure. Other embodiments may be implemented without departing from the scope defined by the appended claims. Variations in form, dimensions, and arrangement of components are contemplated, provided they remain within the claimed subject matter.

1. A CMP polishing pad for polishing a microelectronic substrate comprising:
a pad body comprising a polishing surface, a bottom surface, and a backside between the polishing surface and the bottom surface, the backside having a thickness;
a plurality of hard sections having a geometrical shape defined in the backside of the pad body; and
a plurality of gap sections that extend between and separate the plurality of hard sections,
wherein the pad body comprises a polymer material having
a modulus value greater than 100 MegaPascals or
a Shore D hardness value greater than 50 or
both a modulus value greater than 100 MegaPascals and a Shore D hardness value greater than 50.

2. The polishing pad of claim 1, wherein the pad body comprises a polymer material having a modulus value of at least 100 MegaPascals.

3. The polishing pad of claim 1, wherein a ratio of an area of the hard sections to the area of the gap sections is at least 3 to 1.

4. The polishing pad of claim 1, wherein the hard sections are square-shaped.

5. The polishing pad of claim 1, wherein the gap sections have a width in a range from 0.5 to 12 millimeters.

6. The polishing pad of claim 1, wherein the gap sections are open at the polishing surface.

7. The polishing pad of claim 1, wherein the gap sections are open at the backside.

8. The polishing pad of claim 1, comprising a sub pad that contacts the backside, wherein the gap sections are unfilled.

9. The polishing pad of claim 1, comprising a sub pad that contacts the bottom surface of the polishing pad body, wherein the gap sections are filled with a material of the sub pad.

10. The polishing pad of claim 9, wherein the sub pad comprises polymer material having:
a modulus below 10 MegaPascals, or
a Shore D hardness value below 30, or
both a modulus below 10 MegaPascals and a Shore D hardness value below 30.

11. A method of polishing a microelectronic substrate comprising contacting a surface of a microelectronic substrate with the polishing surface of the CMP pad of claim 1.
